(19) United States
(12) Patent Application Publication
(10) Pub. No.: US 2018/0054401 A1
(43) Pub. Date: Feb. 22, 2018

(54) USER EQUIPMENT MESSAGING IN A CONTENT ON DEMAND NETWORK

(71) Applicant: Canoe Ventures, LLC, Englewood, CO (US)

(72) Inventors: Jason Canney, Highlands Ranch, CO (US); Anne Lisa Morgione, Highlands Ranch, CO (US)

(21) Appl. No.: 15/238,456

(22) Filed: Aug. 16, 2016

(51) Int. Cl. H04L 12/58; H04N 21/4788

(52) U.S. Cl. CPC H04L 51/04; H04N 21/4788

(57) ABSTRACT

Systems and methods presented herein provide for messaging between user equipment (UEs) in a Content On Demand (COD) network. In one embodiment, a system comprises a first COD provider operable to process a request for COD content from a first of a plurality of UEs, to deliver the COD content to the first UE, and to process a first message from the first UE. The first message includes an invitation to a second of the UEs to view the COD content. A router is communicatively coupled to the first COD provider. The router is operable to route the first message to the second UE and to process a selection message from the second UE. The selection message requests that the COD content be delivered to the second UE. The router is further operable to direct a media server to deliver the COD content to the second UE.

### FIELD OF THE INVENTION

The invention relates to the field of messaging between user devices in one or more Content On Demand (COD) networks.

### BACKGROUND

Television networks, such as the American Broadcasting Company (ABC), the Columbia Broadcasting Company (CBS), and the National Broadcasting Company (NBC), have for years broadcast television shows to the masses as a means for generating revenue through advertising. For example, these networks produce television shows and then seek out sponsors to advertise on the shows. The television shows, or “content”, have designated timeslots in which the sponsors' advertisements, or “assets”, are inserted. The content and the inserted assets are then broadcast by the television networks, or “content owners”, to the public over federally licensed communication airways, occasionally referred to as linear video distribution.

However, as the number of advertisers wishing to sell their goods and services increased, television evolved into a much more complex system of communications. Today, a growing number of cable television providers and satellite television providers (e.g., “content providers”) serve as intermediary content providers between the content owners and the intended public audience. And, many members of the general public have signed on as customers of the cable/satellite content providers so as to receive a broader availability of content.

The content providers, in keeping up with the public demand for content, now deliver Content On Demand (COD) so that users can view content at their leisure. COD has created an even more complex system of content delivery for the content providers. And, with the advent of social media, subscribers are now more interested in sharing their viewed content experiences with others.

### SUMMARY

Systems and methods presented herein provide for messaging between UEs (user equipment) in a COD network. In one embodiment, a system comprises a first COD provider operable to process a request for COD content from a first of a plurality of UEs, to deliver the COD content to the first UE, and to process a first message from the first UE. The first message includes an invitation to a second of the UEs to view the COD content. A router is communicatively coupled to the first COD provider. The router is operable to route the first message to the second UE and to process a selection message from the second UE. The selection message requests that the COD content be delivered to the second UE. The router is further operable to direct a media server to deliver the COD content to the second UE.

The various embodiments disclosed herein may be implemented in a variety of ways as a matter of design choice. For example, the embodiments may take the form of physical machines, computer hardware, software, firmware, or combinations thereof In one embodiment, a computer readable medium is operable to store software instructions for directing the asset insertion into content. These software instructions are configured so as to direct a processor or some other processing system to operate in the manner described above. Other exemplary embodiments are described below.

### BRIEF DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of an exemplary COD provider operable to deliver COD content to a plurality of UEs.

FIG. 2 is an exemplary messaging diagram of the COD provider interacting with UEs.

FIG. 3 is a flowchart of an exemplary process of the COD provider routing messages between the UEs for enhanced COD content delivery.

FIG. 4 is a block diagram of an exemplary system employing a router for messaging between the UEs.

FIG. 5 is a flowchart of an exemplary process operable with the router and the COD providers.

FIG. 6 is a flowchart of another exemplary process operable with the router and the COD providers.

FIG. 7 is a block diagram of a headend operable with an exemplary asset decisioning system (ADS) for directing the delivery of assets with the COD content.

FIG. 8 is an exemplary timing diagram of a COD content selection with timeslots available for asset insertion.

FIG. 9 is a block diagram of an exemplary ADS.

FIG. 10 is a block diagram of an exemplary COD provider in a cable television network.

FIG. 11 is a block diagram of an exemplary processing system operable to implement at least portions of the embodiment herein.

### DETAILED DESCRIPTION OF THE DRAWINGS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below.

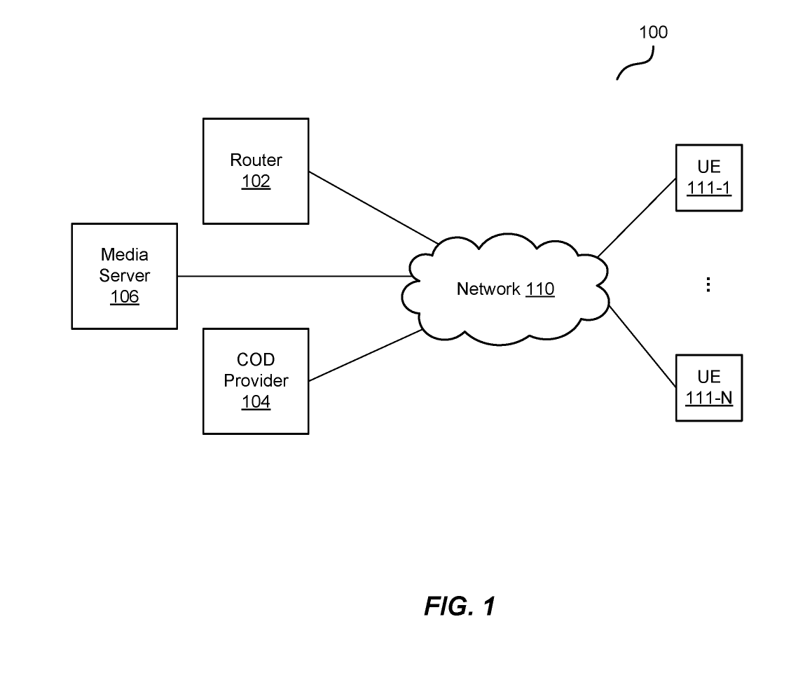

FIG. 1 is a block diagram of an exemplary system 100 with a COD provider 104 operable to deliver COD content to a plurality of UEs 111-1-111-N (where the reference number “N” is an integer greater than “1” and not necessarily equal to any other “N” reference number designated herein). Examples the COD provider 104 include cable television providers, satellite television providers, streaming content providers (e.g., Internet content providers), and the like. Generally, these COD providers 104 provide COD content (e.g., video, audio, data, and various combinations thereof) through their various networks. For example, the network 110 may be representative of a cable television network in which the COD provider 104 is a cable television headend operable to deliver COD content to a variety of set-top boxes (UEs 111) connected to the network 110. In the streaming video example, the network 110 may be the Internet in which the COD provider 104 streams video/audio to UEs 111, such as smart phones, tablet computers, desktop computers, etc. Accordingly, the embodiment disclosed herein is not intended to be limited to any particular type of COD provider. Moreover, the COD provider 104 may be representative of multiple types of COD providers to deliver COD content in a combination of ways.

The system 100 also includes a router 102 that is operable to route messages between the UEs 111. The messages comprise information relating to the COD content deliveries to the UEs 111 such that they may invite other UEs 111 to also experience their COD content deliveries in a sort of COD content social networking environment. For example, the first UE 111-1 may request COD content from the COD provider 104 through the network 110. The COD provider 104 verifies that the UE 111-1 is a subscriber of the COD content and then delivers that COD content to the UE 111-1 for viewing. The user of the UE 111-1 may desire to invite another person to view that same COD content. Accordingly, the user of the UE 111-1 may format a message that includes a title and a description of the COD content being viewed by the user of the UE 111-1. The message may also include information pertaining to the user being invited to view the content (e.g., the user of UE 111-N). This information may include the other user's name, location, and/or other identifying characteristics. This message is transferred to the COD provider 104 which, in turn, sends the message to the router 102 to invite the user 111-N to view the same COD content. If that user is able to view the content and accepts the invitation, the router 102 contacts the media server 106 to deliver the COD content to the UE 111-N.

This messaging can be done in “real time” as the user of the UE 111-1 is viewing the COD content or after the COD content has been viewed by the user of the UE 111-1. For example, if the user of the UE 111-1 enjoyed the COD content and wishes to share that experience with another user, the user of the UE 111-1 may send a message to the user of the UE 111-N to invite the user of the UE 111-N to also view the COD content. Alternatively, the user of the UE 111-1 may wish to view the COD content at the same time the user of the UE 111-N views the COD content, albeit at a different location. In this regard, the system 100 may also enhance the user's experience through social networking to allow the users of the UEs 111-1 and 111-N to communicate with one another during the viewing of the COD content.

The router 102, although shown external to the COD provider 104, can be incorporated into the functionality of the COD provider 104. For example, if the UEs 111-1 and 111-N are subscribers to the same COD provider 104, then the router 102 can simply access a subscriber database of the COD provider 104 and establish a messaging link between the UEs 111-1 and 111-N. However, when the UEs 111-1 and 111-N are subscribers to different COD providers 104, then the router 102 may be configured as an external router that deciphers and translates IDs of the users UEs 111-1 and 111-N to establish the messaging link between the UEs 111-1 and 111-N. For example, COD providers 104 typically assign and maintain user IDs to users of the UEs 111 in a proprietary format. Thus, one COD provider 104 may assign a user ID to a subscriber that differs from the user ID of another COD provider 104. And, when the router 102 receives a message pertaining to an invited user of the UE 111-N from the user of the UE 111-1, the router 102 may ascertain the invited user's identifying information to determine which COD provider 104 that the user of the UE 111-N subscribes to. In this regard, the router 102 is any device, system, software, or combination thereof operable to route messages between UEs 111 in a COD environment.

In some embodiments, the system 100 includes a media server 106 which stores and maintains the COD content. For example, the media server 106 may be a separate entity which holds the COD content on behalf of one or more COD providers 104. Thus, when a UE 111 requests COD content from the COD provider 104, the COD provider 104 may contact the media server 106 to retrieve the COD content and deliver it to the UE 111. Alternatively or additionally, the media server 106 may be incorporated into the functionality of the COD provider 104. Other exemplary embodiments are shown and described below.

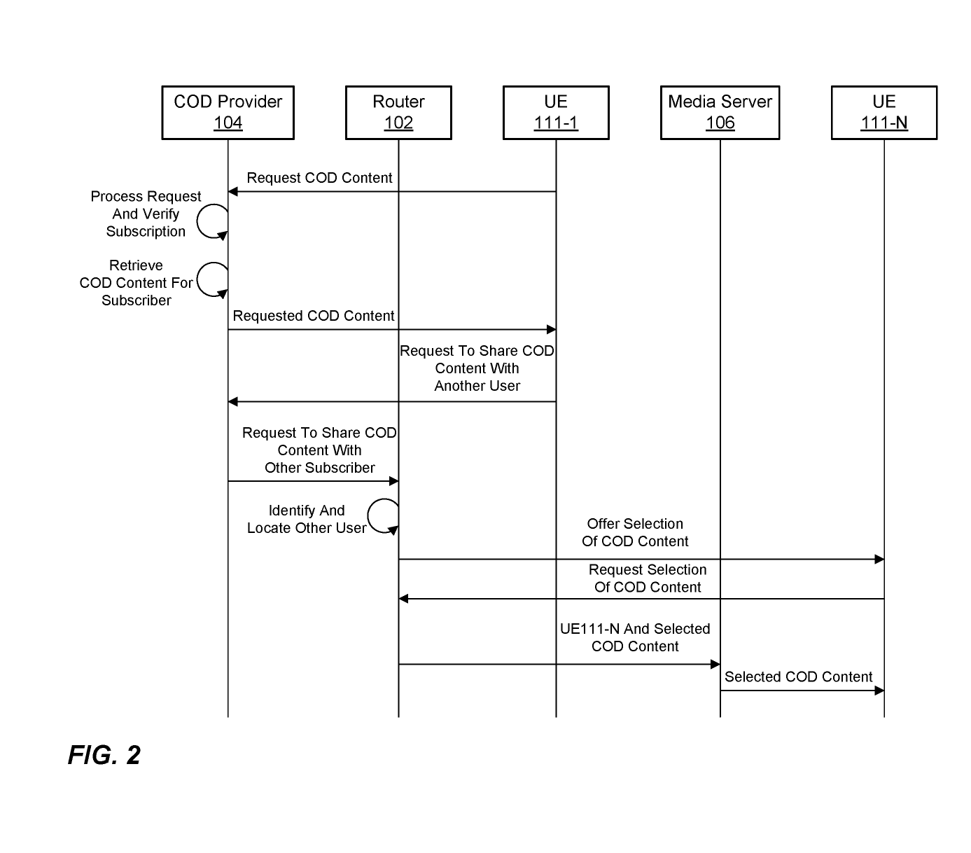

FIG. 2 is an exemplary messaging diagram of the COD provider 104 interacting with UEs 111-1 and 111-N. In this embodiment, the UE 111-1 transmits a request message to the COD provider 104 to request a particular COD content (e.g., a movie, a television show, a music playlist, etc.). Upon receiving the request, the COD provider 104 processes the request and verifies the subscription of the requesting UE 111-1. If the UE 111-1 is a subscriber of the requested COD content, then the COD provider 104 retrieves the COD content from the media server 106 and delivers the requested content to the UE 111-1. Afterwards, the UE 111-1 may then request to share the COD content with another user by transmitting a message to the COD provider 104.

The COD provider 104 transfers the invitation to the router 102 to identify and locate the other user. Once the router 102 identifies and locates the other user, the router 102 transfers an offer message for the COD content to the user 111-N such that the user 111-N may select that content. In this regard, the UE 111-N transfers a message requesting selection of the COD content to the router 102. If the user of the UE 111-N is able to view the COD content (e.g., after determination of whether the user of the UE 111-N is a subscriber of the COD content), then the router 102 contacts the media server 106 to retrieve the selected COD content. The media server 106 then transfers the selected COD content to the UE 111-N for viewing by the user thereof.

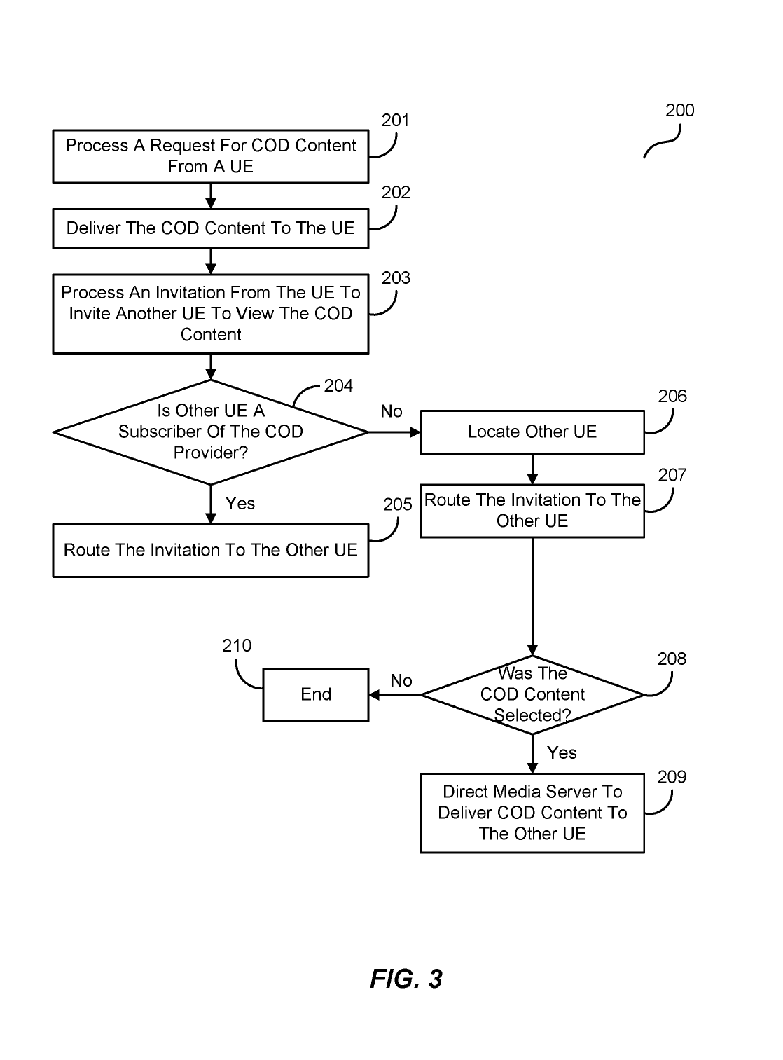

FIG. 3 is a flowchart of an exemplary process 200 of the COD provider 104 routing messages between the UEs 111-1-111-N for enhanced COD content delivery. In this embodiment, the COD provider 104 processes a request for COD content from a UE 111 (e.g., the UE 111-1), in the process element 201, and delivers the COD content to the UE 111, in the process element 202. The COD 104 also processes an invitation from the UE 111 to invite another UE 111 (e.g., the UE 111-N) to view the COD content, in the process element 203. The COD 104 then determines whether the invited UE 111 is a subscriber of the COD provider 104, in the process element 204. If so, the COD provider 104 (e.g., through the router 102) routes the invitation to the other UE 111, in the process element 205.

If the UE 111 is not a subscriber of the COD provider 104, the COD provider transfers the invitation to the router 102 which, in turn, attempts to locate the other UE 111, in the process element 206. For example, the router 102 extracts information pertaining to the identification of the user of the other UE 111 (e.g., the user's name, location, age, etc.) from the invitation. The router 100 then contacts other COD providers 104 to determine if the user of the UE 111 subscribes to any of their services. If one of the other COD providers 104 determines that the user is a subscriber, then the router 102 routes the invitation to the other UE 111 through the other COD provider, in the process element 207.

The invitation routed to the other UE 111 provides a selection option to the user of the other UE 111. For example, if the user of the UE 111-N receives an invitation from a user of the UE 111-1 and the user of the UE 111-N is currently viewing programming from its COD provider 104, the routed invitation may appear on the user's viewing platform (e.g., a television). This invitation may allow the user of the UE 111-N to select the COD content via the user's peripheral device (e.g., a remote control). If the COD content is selected, in the process element 208, then the router 102 directs the media server 106 to deliver the COD content to the UE 111-N, in the process element 209. Otherwise, if the user of the UE 111-N does not select the COD content, then the process 200 may end, in the process element 210.

It should be noted, however, that the invention is not intended to be limited to an invited user having to be currently viewing programming of its COD provider 104. For example, an invitation from a user of the UE 111-1 may be transferred to the UE 111-N and maintained at least for some period of time until the user of the UE 111-N begins viewing the programming from the COD provider 104.

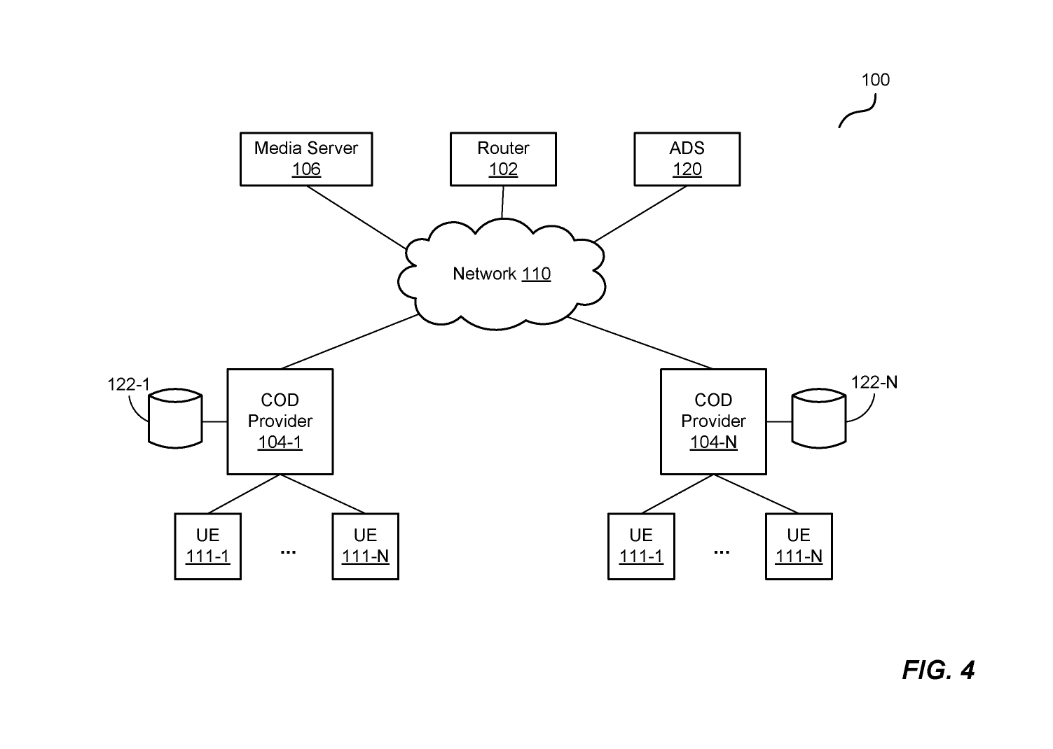

FIG. 4 is a block diagram of another exemplary system 100 employing a router 102 for messaging between the UEs 111. In this embodiment, the system 100 includes a plurality of COD providers 104-1-104-N, each having a respective plurality of UEs 111-1-111-N. Each of the COD providers 104 may include a database 122 of subscribers. Again, the use of “N” reference numbers does not mean the same number of elements.

Typically, a COD provider 104 assigns a user ID to each of its subscribers. In some instances, these user IDs are anonymized so as to protect the identifying characteristics of the subscribers. For example, the COD provider 104-1 may have a subscriber of UE 111-1, John Smith, who resides at 1234 Apple Ln., Minneapolis, Minn. 55401. John Smith may also have his subscription set up as an automatic payment through a credit card, such as MasterCard account number 1234 5678 9012 3456. Through some predetermined anonymization algorithm, John Smith's subscription identifier is generated as JS1234AMMN and is associated with his UE 111.

However, another COD provider 104 having its own subscriber database 122, may have an entirely different subscriber identification format. For example, the COD provider 104-2 may have a subscriber of UE 111-N, Janet Johnson, residing at 56789 Orange Ln., Los Angeles Calif. 90001 who pays her monthly service charges to the COD provider 104-2 by check. The COD provider 104-2 may generate her subscription identifier through its anonymization algorithm as LACA90001JJ56789OL, a format that is different from that of Joe Smith.

The router 102, in this example, is operable to receive an invitation message from the user of the UE 111-1 subscribing to the COD provider 104-1 and extract the identifying information of the user of UE 111-N subscribing to the COD provider 104-N. The router 102 then transfers that information to the other COD providers 104-2-104-N. Since the identifying information may be essentially decoded by the COD provider 104-1, a secure communication link between the COD provider 104-1 and the router 102 may be established to ensure security of the identity of the user of UE 111-N. Similarly, secure communication links between the router 102 and the other COD providers 104-2-104-N may be established to ensure the security of the user of UE 111-N after receiving the message.

Thus, in this example, Joe Smith may send an invitation to Janet Johnson to view a COD content selection of Joe Smith. The router 102 may transfer the invitation pertaining to Janet Johnson to the other COD providers 104-2-104-N to determine if the COD providers have Janet Johnson as a subscriber. Assuming that Janet Johnson is a registered subscriber of the COD 104-N, the COD provider 104-N replies to the router 102 with the LACA90001JJ56789OL ID of the UE 111-N of the COD provider 104-N indicating that Janet Johnson is a registered subscriber of the COD 104-N. The router 102 then transfers the invitation to the UE 111-N through the COD provider 104-N to invite Janet Johnson to view the COD content selected by Joe Smith.

Once Janet Johnson accepts the invitation, the router 102 directs the media server 106 to transfer the COD content to Janet Johnson, assuming for example that she is subscribed to view that content and that the COD provider 104-N is able to deliver that content. If Janet Johnson is not subscribed to view that COD content, the invitation may include an option to purchase the COD content (e.g., via a cash/credit purchase and/or via the option of asset insertions by the asset decisioning system 120, or “ADS 120”). The router 102 may also retain this information for subsequent invitations to expedite the invitation between Joe Smith and Janet Johnson in the future.

Additionally, upon accepting the invitation, the router 102 may establish a secure communication link between Joe Smith and Janet Johnson to communicate during the viewing of the COD content. For example, the router 102 may establish a channel between Joe Smith and Janet Johnson that is activated based on the accepted invitation from Joe Smith. Thereafter, Joe Smith and Janet Johnson can communicate their thoughts on the COD content as part of a social networking embodiment. However, the invention is not intended to be limited to a single invitee. Rather, the router 102 may establish communication links for a plurality of other users invited by the exemplary Joe Smith such that each of the users can communicate during the viewing of the COD content.

Moreover, the router 102 is also operable to ensure that the inviting party (e.g., Joe Smith) is indeed an actual subscriber of the COD provider 104-1. For example, upon receiving an invitation message from the user of the UE 111-1 subscribing to the COD provider 104-1, the router 102 may authenticate the user of the UE 111-1 subscribing to the COD provider 104-1 to ensure that the user is not fraudulent (e.g., a “spamming” entity or the like).

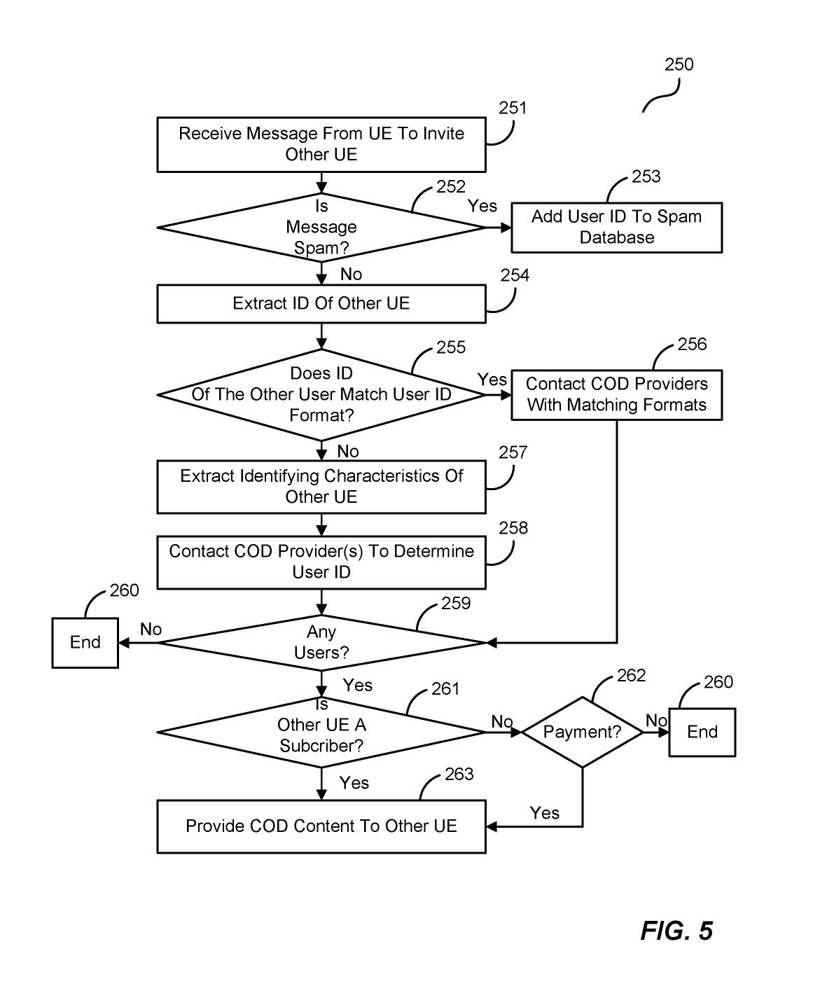

FIG. 5 is a flowchart of an exemplary process 250 operable with the router 102 and the COD providers 104-1-104-N, in accordance with the embodiment of FIG. 4. In this regard, discussion of the embodiment will be made with respect to the exemplary user of the UE 111-1 subscribing to the COD provider 104-1 and the user of the UE 111-N subscribing to the COD provider 104-N.

In this embodiment, the router 102 receives a message from a user of the UE 111-1 subscribing to the COD provider 104-1 to invite the user of the UE 111-N subscribing to the COD provider 104-N, in the process element 251. The router 102 then determines whether the message is spam or some other unauthorized user attempting to contact the user of the UE 111-N, in the process element 252. If the user is unauthorized, then the router 102 prevents the access and adds the user ID of the inviting party to a spam database, in the process element 253. Otherwise, the router 102 extracts the ID of the user of the UE 111-N subscribing to the COD provider 104-N, in the process element 254.

Once the ID is extracted, the router 102 determines whether the ID matches the user ID format of the inviting COD provider 104-1, in the process element 255. For example, if the user ID format matches a format used by the COD provider 104-1 (or any other COD providers 104), then the router 102 may eliminate COD providers 104 not using that format so as to expedite processing. If the user ID of the inviting party matches the format of any of the COD providers 104, the router 102 contacts the COD providers 104, in the process element 256, to determine if any users subscribing to the COD providers have the same or similar user IDs, in the process element 259.

If the user ID does not match the user ID format of any of other COD providers 104, then the router 102 extracts identifying characteristics of the other UE 111-N, in the process element 258 and contacts the other COD providers 104-2-104-N to determine the potential user ID for the invitee, in the process element 258. Then, the router 102 determines if any users match the user ID, in the process element 259. If no users exist, the router 102 discontinues delivery of the invitation and ends the process 250, in the process element 260.

If, however, the user of a UE 111 exists (e.g., the user of the UE 111-N subscribing to the COD provider 104-N), the router 102 contacts the COD provider 104 to determine if that user is a subscriber to the COD content, in the process element 261. For example, the COD content may include a premium subscription, such as “Game of Thrones” by HBO. The user of the UE 111-1 may be a subscriber of that COD content. However, the invited user of the UE 111-N subscribing to the COD provider 104-N may not be a subscriber to that content. If the user of the UE 111-N subscribing to the COD provider 104-N is not a subscriber to the content, the router 102 and/or the COD provider 104-N may route a message allowing the user to pay for the content, in the process element 262.

If the user of the UE 111-N subscribing to the COD provider 104-N does not accept payment, the router 102 declines delivery the COD content to the user, which in turn ends the process 250 in the process element 260. If the user of the UE 111-N subscribing to the COD provider 104-N does provide payment instructions for the COD content, then the router 102 directs the media server 106 to provide the COD content to the user, in the process element 263. Similarly, if the user of the UE 111-N subscribing to the COD provider 104-N is a subscriber to the content, then the router 102 directs the media server 160 provide COD content to the user, in the process element 263.

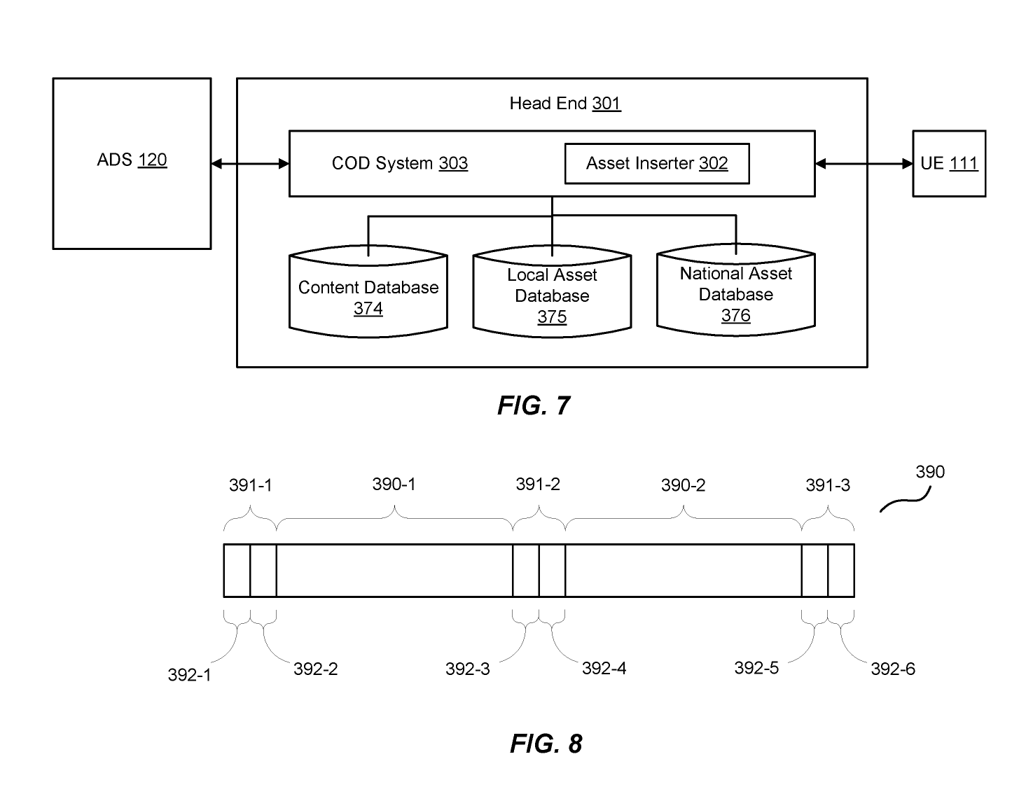

As mentioned, payment for the COD content by the invited party may be made in various forms. For example, the invited party may elect to charge payment to the to the invited user's account with the COD provider 104. Alternatively, the user may provide payment through a credit card that the COD provider 104 charges to allow the delivery of the COD content from the media server 106 to proceed. And, in some embodiments, payment may be made by the invited user by allowing the insertion of advertisements into the COD content. For example, if the user of the UE 111-N subscribing to the COD provider 104-N receives an invitation to view COD content and that user is not a subscriber of the COD content, the router 102 may transfer a request to insert advertisements into the COD content before the user is authorized to view the content. An example of asset insertion is shown and described in greater detail below in FIGS. 7-9.

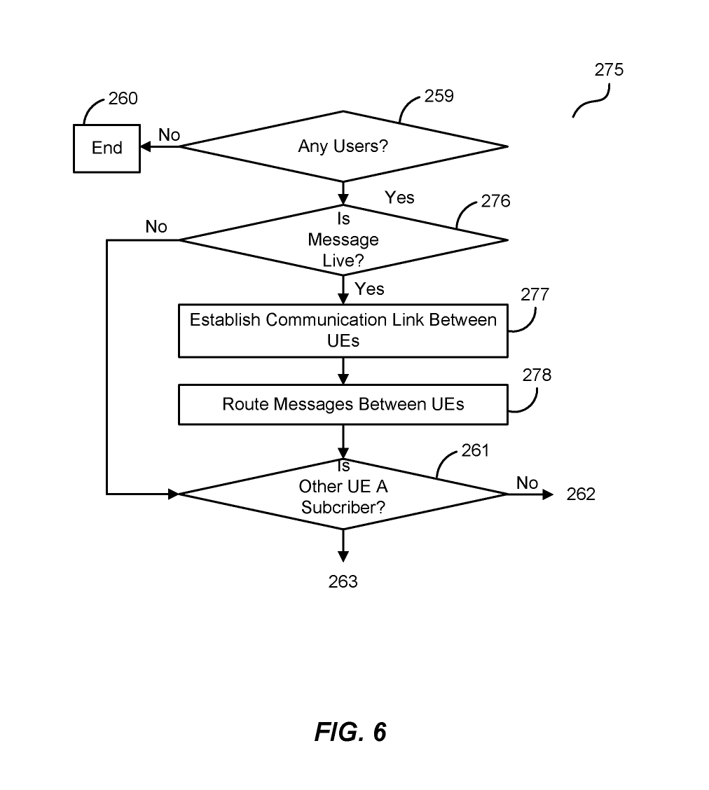

FIG. 6 is a flowchart of another exemplary process 275 operable with the router 102 and the COD providers 104-1-104-N. In this embodiment, the process 275 is an addition to the process 250 of FIG. 5. For example, once the router 102 determines that invited user exists, the router 102 may determine whether the message is a “live” message from the inviting user, in the process element 275. To illustrate, if the user of the UE 111-1 subscribing to the COD provider 104-1 invites the user of the UE 111-N subscribing to the COD provider 104-N and the majority of the process elements of the process 250 have been satisfied, then the router determines if both users are actively preparing to view the COD content.

If the message is not a live message, then the router 102 determines whether the invited user is a subscriber, in the process element 261, and continues the processing of the process 250. Otherwise, the router 102 may establish a communication link between the UEs 111-1 and 111-N of the COD providers 104-1 and 104-N, respectively, in the process element 276. With the link established, the router 102 may then route messages between the UEs 111-1 and 111-N, in the process element 277, as described above.

FIG. 7 is a block diagram of an exemplary ADS 120 operable with a COD system 303 (also known as a “COD back office system”) of a headend 301 (i.e., a COD provider). The ADS 120 illustrates one example of how the ADS 120 may operate. The headend 301, in this embodiment, is generally any system operable to receive content for processing and distribution to a UE 111 (e.g., over a cable television infrastructure or from satellite). For example, the headend 301 may receive content from content providers over television signals for distribution to the customers of a cable content provider via the UE 111.

The COD system 303 of the headend 301 provides the COD content to the UE 111 when desired by the customer. For example, the headend 301 may receive the content from the COD providers 104 and maintain that content within a content database 374. The headend 301 may also maintain local assets in a local asset database 375 and national assets in a national asset database 376. When a particular COD content is selected by the user of the UE 111, an asset inserter 302 of the COD system 303 accesses the content database 374 to retrieve the selected content and deliver that content to the UE 111.

The COD system 303 is any system or device that is operable to deliver video content to the UE 111 when directed by the UE 111. The databases 374, 375, and 376 are any systems or devices operable to store and maintain data, audio, and/or video for subsequent distribution to the UE 111. For example, the databases 374, 375, and 376 may be operable within a computer system that stores the video and audio (e.g., MPEG) content and assets such that they may be accessed by the COD system 303 and delivered to the UE 111 when desired by the user of such. One or more of the databases 374, 375, and 376 may also be configured with the national database 125 described hereinabove.

The UE 111 is any device or system capable of providing content from a content provider 104 to a user. For example, a UE 111 may be a set-top box operable to communicate with a cable television headend. Alternatively, a UE 111 can be a computer capable of displaying video from a network. For example, a UE 111 may select content from an Internet website hosted with an internet server through the network. Once selected, the COD system 303 of the COD provider 104 may retrieve the content from a content database for Internet delivery (e.g., streaming video) to the selecting UE 111. Other examples of the UE 111 include gaming consoles, smart phones, electronic tablets, or the like.

To illustrate the insertion of assets into content, FIG. 8 shows an exemplary timing diagram of content 390 interlaced with asset timeslots 391, also known as “break positions”. When the COD system 303 receives a message from the UE 111 for the content 390, the COD system 303 retrieves the content 390 from the content database 374. The content 390, in this embodiment, is divided into two segments 390-1 and 390-2 with timeslots 391 disposed at the front end of the content 390-1 (i.e., timeslot 391-1 at the pre roll position), in between the content segments 390-1 and 390-2 (i.e., timeslot 391-2 at the mid roll position), and at the end of the content segment 390-2 (i.e., timeslot 391-3 at the post roll position). Each timeslot 391 is divided into two asset placement timeslots 392 (i.e., asset placement opportunities), each of which is capable of accepting an asset that is typically, but not always, 30 seconds in duration. Thus, a placement opportunity is generally a subset of time of a particular timeslot 391. The ADS 120 directs the COD system 303 to insert the assets according to a particular ranking that provides value for the content provider (e.g., monetary value, enhanced relationships with asset providers, etc.). In this regard, the ADS 120 may direct the COD system 303 to select assets from the national asset database 376 and/or the local asset database 375 for insertion into the asset timeslots 392-1-392-6 based on the ranking provided by the ADS 120.

The invention is not intended be limited to any particular number of content segments 390 or any particular number of asset timeslots. In fact, an asset timeslot 392 may be subdivided for insertion of multiple assets. For example, television commercials are typically 30 seconds in length. Occasionally, however, asset providers reduce the material of certain assets to reduce the overall duration of a particular asset (e.g., by removing material from a 30 second commercial to reduce it to a 15 second commercial). Accordingly, a 30 second asset timeslot 392 may be configured to accept insertions of two 15 second assets. For example, the content 390 may be configured with the mid roll timeslot 391-2 having two 30 second asset timeslots 392-3 and 392-4. The asset timeslot 392-3 can thus be further divided into two 15 second asset timeslots 392-3-1 and 392-3-2, allowing for the insertion of two 15 second assets into the asset timeslot 392-3. Still, the invention is not intended to be limited to any particular asset duration, asset timeslot 392 duration, or timeslot 391 duration as such may be configured to meet certain business and/or technical needs.

It should be noted that the decisions regarding the direction of asset insertions occur quite rapidly. For example, the ADS 120 may be operable to make asset insertion decisions for a plurality of headends 301. And, each headend 301 may be operable to provide COD content to a plurality of UEs 111 at any given time, possibly thousands or more. Thus, when a COD content selection is made by a particular UE 111, the ADS 120 responds in substantially real time to ensure that the COD system 303 has ample time to retrieve and insert the assets while processing the content selected by the UE 111.

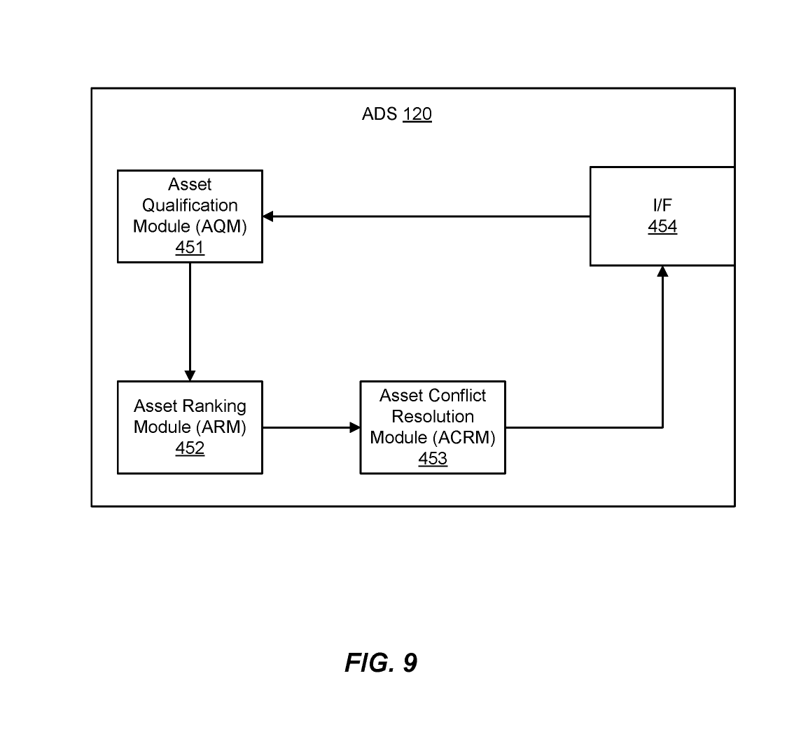

FIG. 9 is a block diagram of an exemplary ADS 120. In this embodiment, the ADS 120 includes an interface 454, an asset qualification module (AQM) 451, an asset ranking module (ARM) 452, and an asset conflict resolution module (ACRM) 453. The interface 454 is any device or system operable to receive information pertaining to a content selection by a UE 111 such that the ADS 120 may direct asset insertion into the selected content. In this regard, the interface 454 may also be operable to transfer information to the COD system 303 to direct the COD system 303 to insert certain assets from the national asset database 376 and/or the local asset database 375.

The AQM 451 is any device or system operable to communicate with the interface 454 to initially qualify assets for insertion within the content. The AQM 451 may exclude certain assets from insertion into the content selected by the UE 111. The ARM 452 is any device or system operable to rank the remaining assets (i.e., those not already excluded by the AQM 451) for insertion to the content 390. The ACRM 453 is any device or system operable to remove any ranked assets from insertion into the content 390 based on conflicts between assets. For example, the ACRM 453 may determine that assets from certain advertisers conflict with one another (e.g., Coke and Pepsi). Accordingly, the ACRM 453 may be operable to prevent assets from these advertisers from being inserted within a same timeslot 391 or even within a same content 390. The exemplary operations of the AQM 451, the ARM 452, and the ACRM 453 are explained in greater detail below.

Overall, the ADS 120 is any system, device, software, or combination thereof operable to process information about assets (e.g., advertisements, marketing materials, etc.) of asset providers/owners such that the ADS 120 can direct a content provider to insert assets from the asset providers into COD content selected by a UE 111. The ADS 120, being communicatively coupled to the COD system 303, processes information pertaining to the content selection and selects assets for insertion into that content from a national asset database and/or a local asset database, as illustrated in FIG. 7. To provide more context to the operations of the ADS 120, the following example is provided.

A UE 111 selects a particular episode of the television show “30 Rock” at 8 pm on a Thursday night from a menu of COD content that is presented by the COD system 303. The COD system 303 retrieves that episode of 30 Rock from the content database 374. The COD system 303 then retrieves certain assets from the national asset database 376 for insertion into the timeslots of that show. As with many other 30 minute situational comedies, this episode of 30 Rock includes two content sections 390-1 and 390-2 and the three timeslots 391-1, 391-2, and 391-3, as illustrated in FIG. 3. Using this example, the COD system 303 transfers an asset insertion request to the AQM 451 to insert assets into these three timeslots. The AQM 451 then determines that there are a total of six 30 second asset placement opportunities within three timeslots 391-1—3 of the selected content 390. The AQM 451 then processes the active campaigns to determine their eligibility within those six 30 second asset placement opportunities. Among the active campaigns in this example are:

1. A Coca-Cola campaign with a total of four assets and 3 campaign items directing placement opportunities of those assets as follows:

a) Asset 1 for 100 views anytime;

b) Asset 2 for any viewing opportunities Monday through Friday between the hours of 5 pm and 10 pm; and

c) Assets 3 and 4 for any viewing opportunities Friday and Saturday between the hours of 5 pm and 10 pm.

2. A Pepsi-Cola campaign with a total of five assets and four campaign items directing placement opportunities of those assets as follows:

a) Asset 1 for 20 views anytime;

b) Asset 2 for 100 views anytime;

c) Asset 3 for 1000 views anytime;

d) Asset 4 for any viewing opportunities Monday through Friday between the hours of 5 pm and 10 pm; and

e) Asset 5 for any viewing opportunities Friday and Saturday between the hours of 5 pm and 10 pm.

3. A Capital One credit card campaign with a total of four assets and three campaign items directing placement opportunities of those assets as follows:

a) Asset 1 for 100 views anytime;

b) Asset 2 for 1000 views anytime; and

c) Assets 3 and 4 for any viewing opportunities Monday through Friday between the hours of 5 pm and 10 pm.

4. A Chrysler Motors campaign with a total of three assets and two campaign items directing placement opportunities of those assets as follows:

a) Asset 1 for 100 views; and

b) Assets 2 and 3 for any viewing opportunities Monday through Friday between the hours of 5 pm and 10 pm.

5. A Nickelodeon campaign with one asset and one campaign item directing placement opportunities of that asset as follows:

a) Asset 1 for 100 views.

Since the television show 30 Rock has a mature theme and since the Nickelodeon campaign is directed towards a younger audience, that campaign item is automatically excluded from the eligible campaign list by the AQM 451. Other remaining campaign items are excluded based on time and date (i.e., campaign items 1c and 2e).

Thus the remaining campaigns of 1a-1b, 2a-2d, 3a-c, 4a-4b are transferred to the ARM 452 for ranking. Based on various factors explained in greater detail below, the ARM 452 ranks the campaigns as follows:
1. Campaign Item 2a
2. Campaign Item 1a
3. Campaign Item 3c
4. Campaign Item 2b
5. Campaign Item 4b
6. Campaign Item 4a
7. Campaign Item 1b
8. Campaign Item 1d
9. Campaign Item 2c
10. Campaign Item 1c
11. Campaign Item 2d
12. Campaign Item 3a
13. Campaign Item 3b

The ARM 452 transfers this ranked list of campaign items to the ACRM 453 to determine conflicts within the ranked list of campaign items. Typically, the six available asset placement opportunities 392-1—6 within the content 390 would be filled by the first six campaign items based on a rank determined by the ARM 452. However, since some conflicts may exist between campaigns within a particular content and/or timeslot, certain campaigns may be excluded from the placement opportunities 392 such that the ranking is reordered. For example, certain criteria may dictate that a Pepsi Cola asset may not be placed within the same content as a Coca-Cola asset. In this regard, the campaign items 1a-1d are removed from the ranked list because the Pepsi-Cola asset has the higher initial ranking, leaving the following campaign items:
1. Campaign Item 2a
2. Campaign Item 3c
3. Campaign Item 2b
4. Campaign Item 4b
5. Campaign Item 4a
6. Campaign Item 2c
7. Campaign Item 2d
8. Campaign Item 3a
9. Campaign Item 3b

With this computed, the ACRM 453 may remove the final three campaign items 7, 8, and 9 from the list as the six placement opportunities can be filled with assets. The ACRM 453 then transfers this information regarding asset placement to the COD system 303.

Once all of the campaign items at each campaign have been evaluated and no campaigns remain or once all of the placement opportunities have been filled, the ACRM 453 directs the COD system 303 to retrieve the assets based on the list generated. For example, the list may be included in a report message that is transferred to the COD system 303 to direct the COD system 303 to insert the assets into the content selected by the UE 111. It is possible that all of the assets have been excluded during the processes described herein. Thus, the ACRM 453 may then direct the COD system 303 to not place any assets in the content selected by the UE 111.

The ACRM 453 may even direct the COD system 303 to place assets from the local database 375 and/or the national database 376 into the selected COD content as desired. The ACRM 453 may also direct the COD system 303 to place assets relating to content, programming, or even services provided by the content provider. For example, if no assets remain, standard programming information, such as time and date, pertaining to the selected COD content may be configured as an asset and placed in the selected COD content. To further illustrate, when an episode of “Modern Family” is selected by a UE 111 and no assets remain for insertion into the available time slots of that episode, the ACRM 453 may direct the COD system 303 to present the user of the UE 111 with the date and time when the next episode of Modern Family can be seen.

Since it is also possible that not all of the assets in the list may be placed as there may be more assets than available opportunities, the ACRM 453 may weight the assets prior to placement in the selected COD content. For example, certain assets may provide greater value to the content provider (e.g., the television network). In this regard, the ACRM 453 may rank the remaining assets in a manner that provides the most monetary compensation to the content provider. Thus, the ACRM 453 may reduce the list of available assets for insertion to the amount of opportunities, or timeslots, in the selected COD content to provide this value to the content provider. In any case, the ACRM 453 directs the COD system 303 to place the assets in the selected COD content based on the ranked list. Once placement has been directed, the ACRM 453 generates a placement report and transfers that report to the headend 301 so that the headend 301 can track marketing views (e.g., for later negotiations between content providers and marketers). For example, when a marketer can know how many views of a particular asset there were in a selected COD content, the marketer can assign a value to that asset that may be used in negotiating price for additional views of the asset in future selected COD content.

Generally, assets promoting products and services are maintained in databases by asset owners. A campaign manager may include the databases that store local and national advertisements for COD content insertion in addition to the various campaign rules that are to be implemented with the COD content insertion. For example, the asset owners develop campaigns which are subsequently managed and maintained by the campaign manager. The asset campaigns comprise rules and asset descriptions (e.g., configured as a data structure) that an asset owner may believe serves the asset owner's best marketing interests. Then, these campaigns are passed to the ADS 120 for the ADS 120 to determine the best manner in which the assets of the asset owners are to be inserted into the COD content provided by the COD provider 104.

The rules of the asset campaigns assist the ADS in determining how to exclude and/or promote certain assets in the COD content. For example, the Coca-Cola Company may have a number of advertisements it wishes to be inserted into COD content. Each of those advertisements may be associated with a campaign that targets various demographics of viewers (e.g., age, sex, ethnicity, location, etc.). Some of those assets may even cross multiple campaigns. And, each asset campaign has rules that may, for example, prevent Pepsi-Cola Company advertisements from being inserted too close in time to Coca-Cola advertisements. The campaign manager 102 manages these asset campaigns and provides them to the ADS 120 such that the ADS 120 can select assets that provide value to the COD provider 104 while complying with the rules of the asset campaigns.

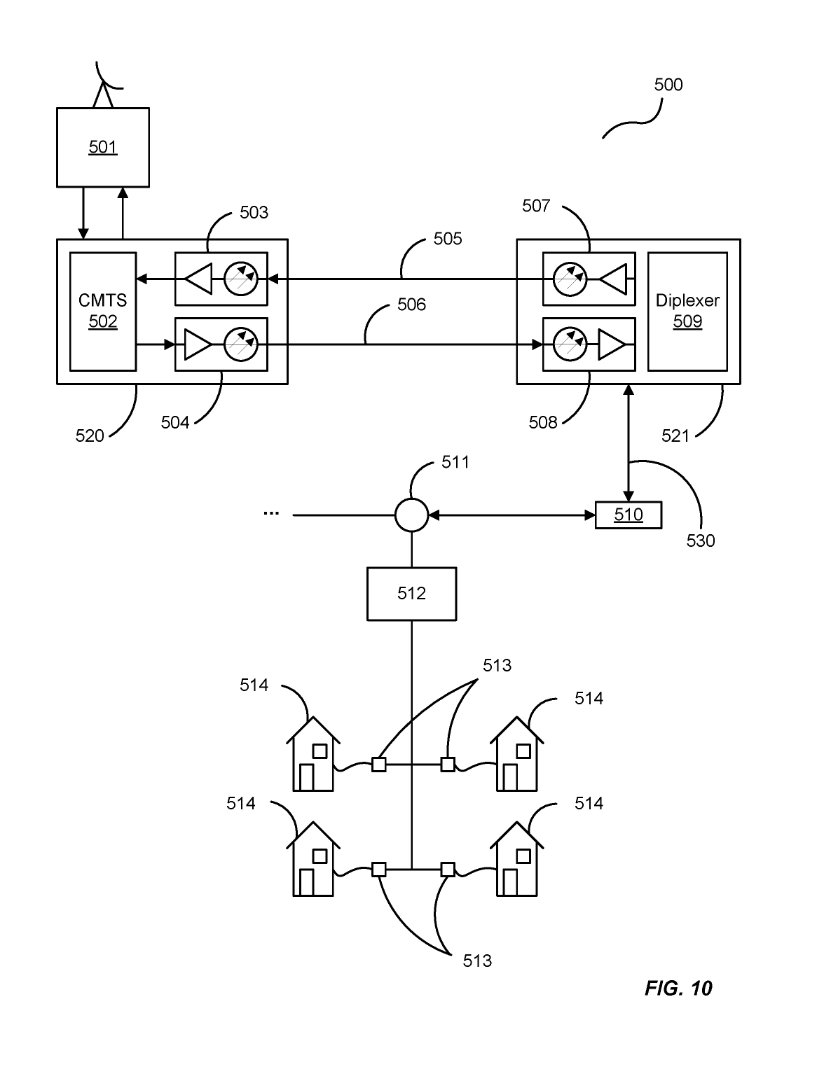

FIG. 10 is a block diagram of an exemplary communication system 500. More specifically, the system is a cable television communication system with high speed data services being delivered over devices conforming to the Data Over Cable Service Interface Specification (DOCSIS) specification. In this regard, the communication system may link the UEs 111 through DOCSIS messaging such that they may communicate COD content selections to other users and invite them to view the COD content as well.

The communication system includes a headend 501 configured with an upstream hub 520. The hub 520 is coupled to a fiber node 521 via optical communication links 505 and 506. The fiber optic links 505 and 506 are typically driven by laser diodes, such as Fabry Perot and distributed feedback laser diodes. The hub 520 includes a Cable Modem Termination System (CMTS) 502, an electrical to optical converter 503, and an optical to electrical converter 504. The node 521 is similarly configured with an optical to electrical converter 508 and an electrical to optical converter 507.

The headend 501 is the source for various television signals. Antennas may receive television signals that are converted as necessary and transmitted over fiber optic cables 505 to the hub 520. Several hubs may be connected to a single headend 501 and the hub 520 may each be connected to several nodes 521 by fiber optic cable links 505 and 506. The CMTS 502 may be configured in the headend 501 or in the hub 520.

Downstream, in homes/businesses are devices and data terminals such as Cable Modems (CMs; not shown) or other UEs 111. A CM acts as a host for an Internet Protocol (IP) device such as personal computer. Transmissions from the CMTS 502 to the CM are carried over the downstream portion of the cable television communication system generally in the band between 54 and 860 MHz. Downstream digital transmissions are continuous and are typically monitored by many CMs. Upstream transmissions from the CMs to the CMTS 502 are typically carried in the 5-42 MHz frequency band, the upstream bandwidth being shared by the CMs that are on-line. However, with greater demands for data, additional frequency bands and bandwidths are continuously being deployed in the downstream and upstream paths.

The CMTS 502 connects the local CM network to the Internet backbone. The CMTS 502 connects to the downstream path through an electrical to optical converter 504 that is connected to the fiber optic cable 506, which in turn, is connected to an optical to electrical converter 508 at the node 521. The signal is transmitted to a diplexer 509 that combines the upstream and downstream signals onto a single cable. The diplexer 509 allows the different frequency bands to be combined onto the same cable.

After the downstream signal leaves the node 521, the signal is typically carried by a coaxial cable 530. At various stages, a power inserter 510 may be used to power the coaxial line equipment, such as amplifiers or other equipment. The signal may be split with a splitter 511 to branch the signal. Further, at various locations, bi-directional amplifiers 512 may boost and even split the signal. Taps 513 along branches provide connections to subscriber's homes 514 and businesses.

Upstream transmissions from subscribers to the hub 520/headend 501 occur by passing through the same coaxial cable 530 as the downstream signals, in the opposite direction on a different frequency band. Upstream transmissions are typically sent in a frequency/time division multiplexing access (FDMA/TDMA) scheme, for example, as specified in DOCSIS standards. The diplexer 509 splits the lower frequency signals from the higher frequency signals so that the lower frequency, upstream signals can be applied to the electrical to optical converter 507 in the upstream path. The electrical to optical converter 507 converts the upstream electrical signals to light waves which are sent through fiber optic cable 505 and received by optical to electrical converter 503 in the node 520.

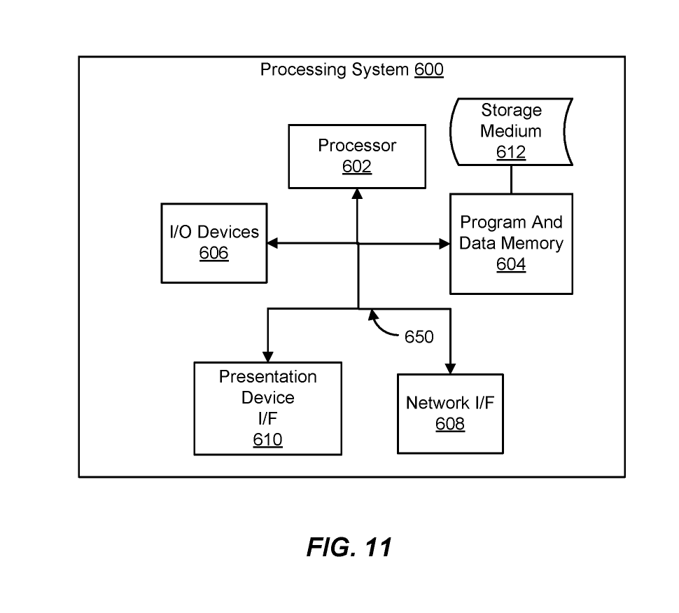

FIG. 11 illustrates an exemplary processing system 600 that is operable to implement one or more of the embodiments hereinabove. For example, some of the embodiments of the invention can take the form of a computer program accessible via the computer-readable storage medium 612. The storage medium provides program code for use by a computer or any other instruction execution system. For the purposes of this description, computer readable storage medium 612 can be anything that can contain, store, communicate, or transport the program for use by a computer.

The computer readable storage medium 612 can be an electronic, magnetic, optical, electromagnetic, infrared, or semiconductor device. Examples of computer readable storage medium 612 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

The processing system 600, being suitable for storing and/or executing the program code, includes at least one processor 602 coupled to memory elements 604 through a system bus 650. Memory elements 604 can include local memory employed during actual execution of the program code, bulk storage, and cache memories that provide temporary storage of at least some program code and/or data in order to reduce the number of times the code and/or data are retrieved from bulk storage during execution.

Input/output (I/O) devices 606 (including but not limited to keyboards, displays, pointing devices, etc.) can be coupled to the processing system 600 either directly or through intervening I/O controllers. Network adapter interfaces 608 may also be coupled to the system to enable the processing system 600 to become coupled to other processing systems or storage devices through intervening private or public networks. Modems, cable modems, IBM Channel attachments, SCSI, Fibre Channel, and Ethernet cards are just a few of the currently available types of network or host interface adapters. Presentation device interface 610 may be coupled to the system to interface to one or more presentation devices, such as printing systems and displays for presentation of presentation data generated by the processor 602.

While the invention has been illustrated and described in detail in the drawings and foregoing description, such illustration and description is to be considered as exemplary and not restrictive in character. Certain embodiments described hereinabove may be combinable with other described embodiments and/or arranged in other ways. Accordingly, it should be understood that only a preferred embodiment and variants thereof have been shown and described and that all changes and modifications that come within the spirit of the invention are desired to be protected.

Additionally, although the term “headend” generally suggests the distribution center or office of a cable television operator or MSO (Multi-System Operator), the term is not intended to be so limited. The term headend as used herein is any system operable to deliver content to a viewer (e.g., a customer or user of the UE 111). For example, the term headend may encompass satellite content providers that offer COD content and/or Internet services to its subscribers. That content is typically delivered directly to the subscriber's antenna for demodulation and decryption by the subscriber's UE 111. Internet traffic in such a system may be conveyed by satellite and/or other delivery mechanisms (e.g., digital subscriber lines, or “DSL”, delivered through subscriber phone lines).

A headend may also refer to a telecom provider that distributes content to mobile phones and other devices. Also, the term “asset”, as used herein, includes any type of media for which an owner desires promotion. Examples of such include traditional television commercials, advertisements, streaming video commercials, promotional materials, marketing information, and the like. The term “content”, as used herein, is any type of media, such as audio and/or video, in which assets may be inserted. For example, the content operable within the COD delivery systems described herein may be streamed Internet audio/video, analog cable television feeds, digital cable television feeds, digital satellite television feeds, or digital satellite radio feeds. Thus, the content of the COD described herein is intended to encompass Video on Demand (VOD) and pay-per-view (PPV) delivered by both modern cable television and satellite television.

What is claimed is:

1. A system operable in a Content On Demand (COD) environment, the system comprising:
a first COD provider operable to process a request for COD content from a first of a plurality of user equipment (UEs), to deliver the COD content to the first UE, and to process a first message from the first UE, wherein the first message includes an invitation to a second of the UEs to view the COD content; and
a router communicatively coupled to the first COD provider, wherein the router is operable to route the first message to the second UE and to process a selection message from the second UE, wherein the selection message requests that the COD content be delivered to the second UE, wherein the router is further operable to direct a media server to deliver the COD content to the second UE.

2. The system of claim 1, wherein:
first COD provider comprises the media server.

3. The system of claim 1, wherein:
the first COD content provider comprises a database of subscribers of the first COD provider;
the first UE belongs to a first of the subscribers of the first COD provider;
the second UE belongs to a subscriber of another COD provider;
the first COD provider is further operable to determine that the second UE does not belong to any of the subscribers in the database, and to direct the router to identify the second UE; and
the router is further operable to direct the other COD provider to identify the second UE, and to route the first message to the second UE in response to the other COD provider identifying the second UE.

4. The system of claim 3, wherein:
the other COD provider is operable to determine that the second UE does not have a subscription for the COD content, and to offer a purchasing opportunity for the COD content to the second UE.

5. The system of claim 4, wherein:
the purchasing opportunity allows a subscriber of the other COD provider to purchase the COD content through the second UE by charging an account of a subscriber of the other COD provider.

6. The system of claim 4, wherein:
the purchasing opportunity provides the second UE with an advertisement selection message that allows a subscriber of the other COD provider to receive advertisements inserted into the COD content in lieu of payment.

7. The system of claim 6, further comprising:
an asset decision system (ADS) operable to interact with the other COD provider to determine the COD content, to evaluate a plurality of assets for insertion into the COD content, to rank the evaluated assets, and to direct the other COD provider to insert the ranked assets.

8. The system of claim 1, wherein:
the router is further operable to establish a communication link between the first and the second UEs based on the first message, and to transfer subsequent messages between the first and the second UEs while the COD content is viewed.

9. The system of claim 1, wherein:
the COD provider is operable to determine that the second UE does not have a subscription for the COD content, and to offer a purchasing opportunity for the COD content to the second UE.

10. A method operable in a Content On Demand (COD) environment, the method comprising:
via a first COD provider:
processing a request for COD content from a first of a plurality of user equipment (UEs);
delivering the COD content to the first UE; and
processing a first message from the first UE, wherein the first message includes an invitation to a second of the UEs to view the COD content; and
the method further comprising:
routing the first message to the second UE; and
processing a selection message from the second UE, wherein the selection message requests that the COD content be delivered to the second UE; and
directing a media server to deliver the COD content to the second UE.

11. The method of claim 10, wherein:
first COD provider comprises the media server.

12. The method of claim 10, wherein:
the first COD content provider comprises a database of subscribers of the first COD provider;
the first UE belongs to a first of the subscribers of the first COD provider;
the second UE belongs to a subscriber of another COD provider;
the method further comprises:
via the first COD provider:
determining that the second UE does not belong to any of the subscribers in the database;
directing the router to identify the second UE; and
via the router, directing the other COD provider to identify the second UE;
routing the first message to the second UE in response to the other COD provider identifying the second UE.

13. The method of claim 12, further comprising:
via the other COD provider, determining that the second UE does not have a subscription for the COD content; and
offering a purchase opportunity for the COD content to the second UE.

14. The method of claim 13, further comprising:
charging an account of a subscriber of the other COD provider in response to a subscriber of the other COD provider purchasing the COD content through the second UE.

15. The method of claim 13, further comprising:
directing insertion of advertisements into the COD content in response to a subscriber of the other COD provider selecting an advertisement option in lieu of payment.

16. The method of claim 15, further comprising:
interacting with the other COD provider to determine the COD content;
evaluating a plurality of assets for insertion into the COD content;
ranking the evaluated assets; and
directing the other COD provider to insert the ranked assets.

17. The method of claim 10, further comprising:
establishing a communication link between the first and the second UEs based on the first message; and
transferring subsequent messages between the first and the second UEs while the COD content is viewed.

18. The method of claim 10, further comprising:
determining that the second UE does not have a subscription for the COD content; and
offering a purchasing opportunity for the COD content to the second UE.
